(19) United States
(12) Patent Application Publication
(10) Pub. No.: US 2013/0263841 A1
(43) Pub. Date: Oct. 10, 2013

(54) Fire Pit Shipping and Packaging Systems and Methods

(71) Applicant: MORTARLESS TECHNOLOGIES LLC, Rochester, MN (US)

(72) Inventors: Dirk Allan Terpstra, Oronoco, MN (US); Brian A. Price, Rochester, MN (US); Chris Edward Price, Rochester, MN (US)

(21) Appl. No.: 13/860,131

(22) Filed: Apr. 10, 2013

Related U.S. Application Data
(60) Provisional application No. 61/622,887, filed on Apr. 11, 2012.
(60) Provisional application No. 61/622,489, filed on Apr. 10, 2012.

(51) Int. Cl. A47J 37/07; B65G 57/02; B65B 11/00

(52) U.S. Cl. CPC A47J 37/0759; B65B 11/00; B65G 57/02
USPC 126/25 R; 53/461; 414/802; 414/800

(57) ABSTRACT

A fire-pit assembly kit includes a fire-pit insert packaged with a plurality of blocks arranged around the fire-pit insert. A method of transporting the kit includes placing the kit on a pallet and moving the pallet from a first location to a second location. A method of preparing the kits for delivery includes assembling multiple kits on multiple pallets and stacking the pallets.

### CROSS-REFERENCE TO RELATED APPLICATIONS

This application claims the benefit of U.S. Provisional Application Ser. No. 61/622,887, filed Apr. 11, 2012 and U.S. Provisional Application Ser. No. 61/622,489, filed Apr. 10, 2012. The disclosures of the prior applications are considered part of (and are incorporated by reference in) the disclosure of this application.

### TECHNICAL FIELD

This document relates to systems and techniques for packaging and/or shipping fire pit assembly systems.

### BACKGROUND

Fire pits are designed to contain a fire and prevent it from spreading. Fire pit designs range from pits dug into the ground to elaborate gas burning compilation of stone, brick, and/or metal. Pre-made and portable metal fire pits are a common form of fire pit and can be purchased from a store. Assembled fire pits can be assembled from a combination of bricks, stone, concrete, and/or metal. Because assembled fire pits are very heavy, they are essentially locked into wherever they are placed.

### SUMMARY

A fire-pit assembly kit includes a fire-pit insert packaged with a plurality of blocks arranged around the fire-pit insert. A method of transporting the kit includes placing the kit on a pallet and moving the pallet from a first location to a second location. A method of preparing the kits for delivery includes assembling multiple kits on multiple pallets and stacking the pallets.

The details of one or more embodiments are set forth in the accompanying drawings and the description below. Other features and advantages will be apparent from the description and drawings, and from the claims.

### DESCRIPTION OF DRAWINGS

FIG. 1 is a perspective view of a fire pit.

FIG. 2 shows an example of a fire pit assembly kit.

FIG. 3 shows a fire-pit insert, a swiveling grate, and how the fire-pit insert and the swivel grate can be assembled.

FIG. 4 is a perspective view of a swivel grate.

FIG. 5 is a perspective view of a packaged grate.

FIG. 6 shows possible accessories that may be included with the fire pit assembly kit.

FIG. 7 shows an example of how fire pit assembly kits may be arranged for shipping.

### DETAILED DESCRIPTION

This document describes systems and techniques for packaging and/or shipping fire pit assembly systems. The total weight of an assembled fire pit can be heavy. An assembled fire pit may be too heavy for workmen to carry by hand. Moreover, the desired placement for a fire pit may be remote from a path from where a vehicle can transport an assembled fire pit. Accordingly, this document describes fire-pit assembly systems designed to permit workmen to individually transport the elements of the fire pit from a vehicle access point to the fire-pit assembly location, while also allowing for an efficient shipping and distribution of multiple fire-pit assembly kits that minimizes damage to the elements of the kits.

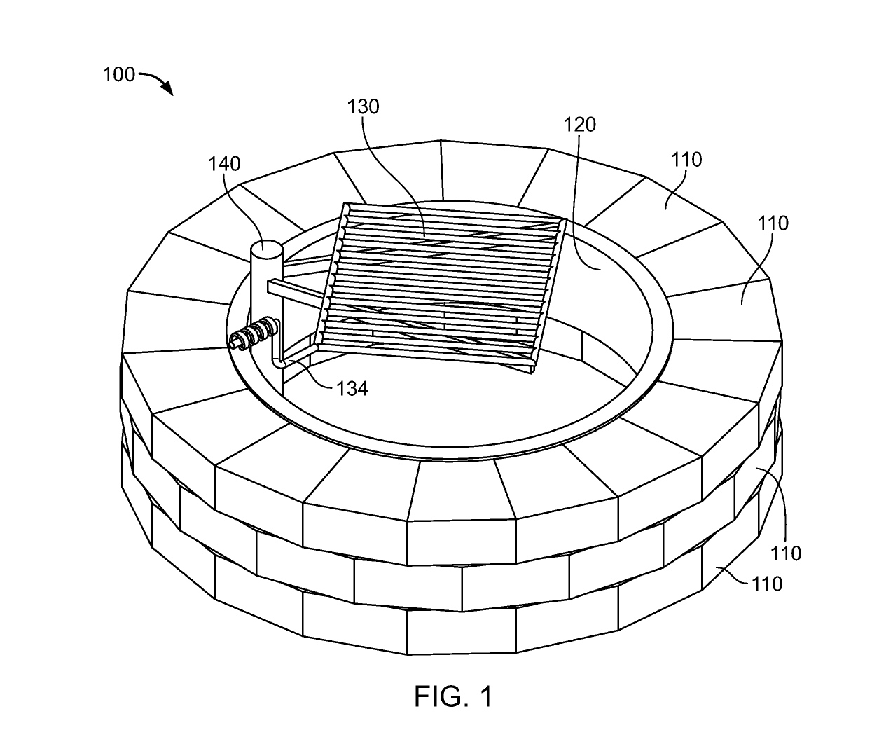

FIG. 1 is a perspective view of an assembled fire pit 100 according to certain embodiments. A fire pit having this arrangement is disclosed in further detail in U.S. Design Pat. No. D648,428, which is hereby incorporated by reference. The fire pit 100 includes a plurality of blocks 110 arranged circumferentially around a fire-pit insert 120. The fire-pit insert 120 can keep the blocks 110 from overheating and cracking if the fire pit is suddenly cooled (e.g., by rain or a bucket of water). The fire pit 100 can optionally include a grate 130 and a post 140 for holding the grate 130 over the fire pit. The grate 130 can include a handle 134 used to pivot the grate 130 relative to the fire-pit insert 120. Fire pits can also include a variety of additional accessories, some of which are described below.

As shown in FIG. 1, the fire-pit insert 120 can be circular. In other embodiments, the fire-pit insert 120 can have non-circular shapes. For example, the fire-pit insert 120 can be ovular, oblong, egg-shaped, or rectangular. The fire-pit insert can have a single-piece construction. The fire-pit insert 120 can be made of metal. In some embodiments, the fire-pit insert 120 can include 10 gauge steel. In still other embodiments, the fire ring insert can be made out of ceramic material. As shown in FIG. 1, the fire-pit insert has smooth sides. In other embodiments, the fire-pit insert 120 can have textured or corrugated surfaces. The fire-pit insert can also include an upper lip as shown in FIG. 1.

The blocks 110 can be made out of a variety of materials. In some embodiments, the blocks 110 include high-density concrete. In some embodiments, the blocks 110 are made out of cut stone. In some embodiments, the blocks 110 include a ceramic material. For example, the blocks 110 can be clay bricks. The blocks 110 can be mortarless blocks, adapted allow for the blocks to remain stacked in the desired configuration without adhesive or mortar despite normal environmental forces. For example, mortarless blocks 110 can each have a weight of at least 10 pounds and have a coefficient of friction of at least 0.6 under dry conditions. In some embodiments, the coefficient of friction between two blocks can be greater than 1.0 under dry conditions. In use, however, mortarless blocks can be secured together with an adhesive to minimize shifting of the blocks 110 due to environmental exposure.

As shown in FIG. 1, the blocks 110 can have a trapezoidal shape with a flat upper surface and a flat lower surface. The blocks 110 can have dimensions such that a predetermined number of blocks 110 can be arranged in a ring without substantial gaps between each block. In some embodiments, the circular fire-pit insert 120 is dimensioned to fit within the ring of blocks. In some embodiments, the fire-ring insert has an outer diameter that is less than 3 inches smaller than the inner diameter of the ring of blocks. In some embodiments, the fire-pit insert has an outer diameter that is less than 1 inch smaller than the inner diameter of the ring of blocks. In other embodiments, the blocks 110 can have other shapes. In some embodiments, the blocks can have other shapes adapted to be arranged in a ring with adjacent block surfaces placed against each other without substantial gaps. For example, the sider surfaces of the blocks 110 could be curved. In other embodiments, the blocks 110 can be irregularly shaped and be intended to have gaps therebetween. In still other embodiments, the blocks 110 can be rectangular.

The fire pit 100 can include multiple layers of block rings. As shown in FIG. 1, the fire pit 100 can include 3 layers of block rings. As shown, the multiple layers of blocks have a height that is greater than the height of the fire-pit insert 120. The blocks in adjacent layers can be aligned or offset from each other when the fire pit 100 is assembled. In other embodiments, the fire pit 100 can include a single layer of blocks formed into a block ring around the fire-pit insert 120.

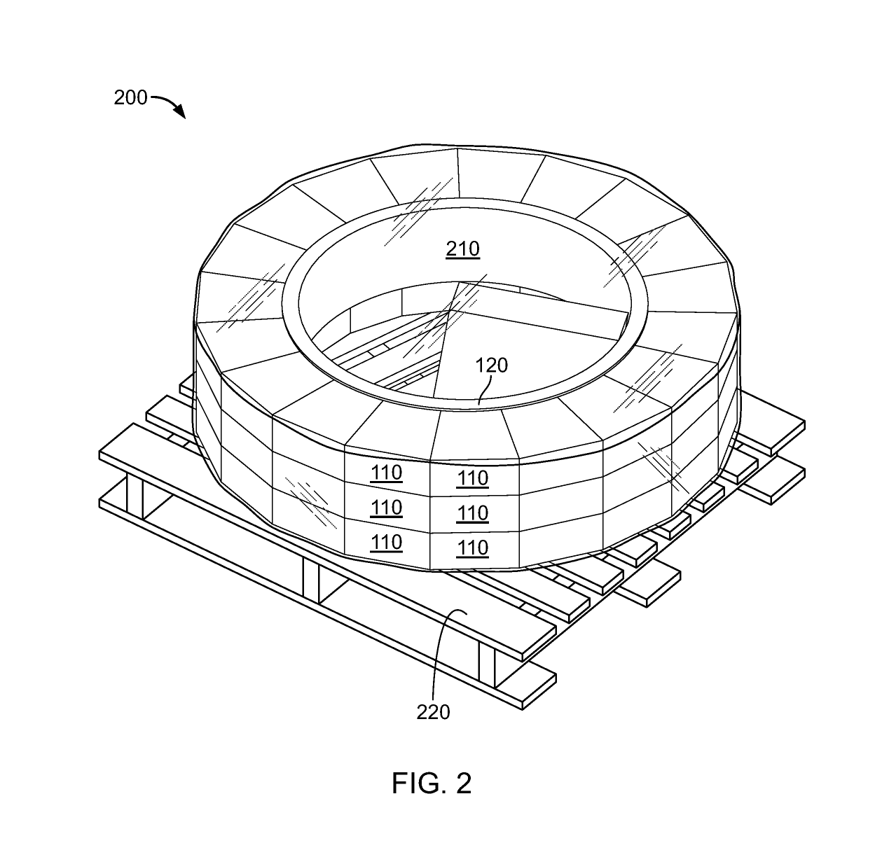

A fire-pit assembly kit 200 for making a fire pit 100 can include the fire-pit insert 120 and a plurality of blocks 110. As shown in FIG. 2, the fire-pit assembly kit 200 includes the blocks 110 arranged around the fire-pit insert 120. As shown, the blocks 110 are arranged to form a block ring around the fire-pit insert 120 within the packaging 210. The packaging 210 can be plastic material 210 wrapped around and/or encasing the fire-pit insert 120 and the plurality of blocks 110. In other embodiments, different packaging materials can be used. In some embodiments, accessories and/or tools for assembling the fire pit can be included in the fire-pit assembly kit 200. These accessories and/or tools can be packaged in the middle of the fire-pit insert 120. Possible accessories and tools are further discussed below.

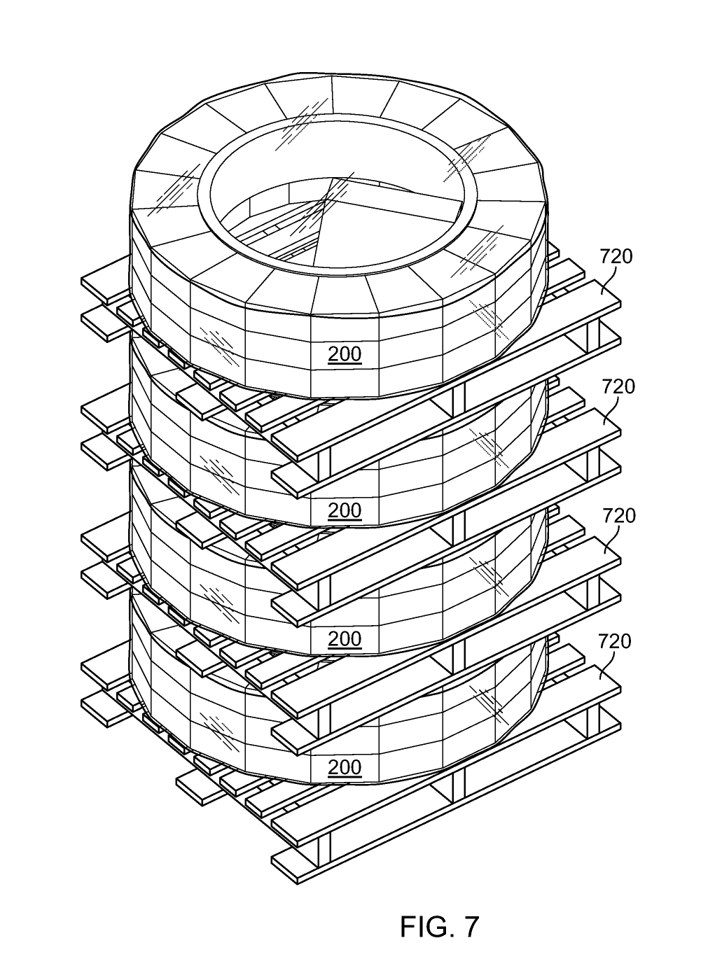

The blocks 110 are arranged round the fire-pit insert 120 in the packaging 210 and during shipment of the fire-pit assembly kit 200 so that the blocks 110 can protect the fire-pit insert 120. For example, multiple fire-pit assembly kits can be stacked on top of each other, as shown in FIG. 7. The placement of the rings of blocks 110 around each fire-pit insert 120 can prevent the weight of another fire-pit assembly kit 200 from damaging the fire-pit insert 120 of the fire-pit assembly kit stacked below. The blocks 110 within a fire-pit assembly kit can be stacked higher than the height of the fire-pit insert 120. The fire-pit assembly kit 200 can be place on a pallet 220 to facilitate the shipment of the fire-pit assembly kit 200 to a vehicle access point where the kit 200 can be disassembled and moved piece-by-piece by workmen to a fire-pit assembly location where the fire pit is assembled.

The fire-pit assembly kit 200 can be mortarless within the packaging 210 and/or on the pallet 220. Within the kit 200, the blocks 110 are not bonded together (e.g., by mortar or adhesive). As discussed below, the blocks 110 can later be assembled into a finished fire pit with our without adhesive or mortar to hold the bricks together, but the fire-pit assembly kit 200 includes blocks that are loose with respect to each other. Within the kit 200, the plurality of blocks 110 and the fire-pit insert 120 are held together by the packaging material 210, friction, and gravity. In some embodiments, multiple layers of block rings are stacked such that the blocks 110 in adjacent layers are approximately aligned. For example, FIG. 2 depicts blocks 110 in adjacent layers that are approximately aligned. In other embodiments, blocks in adjacent layers are offset.

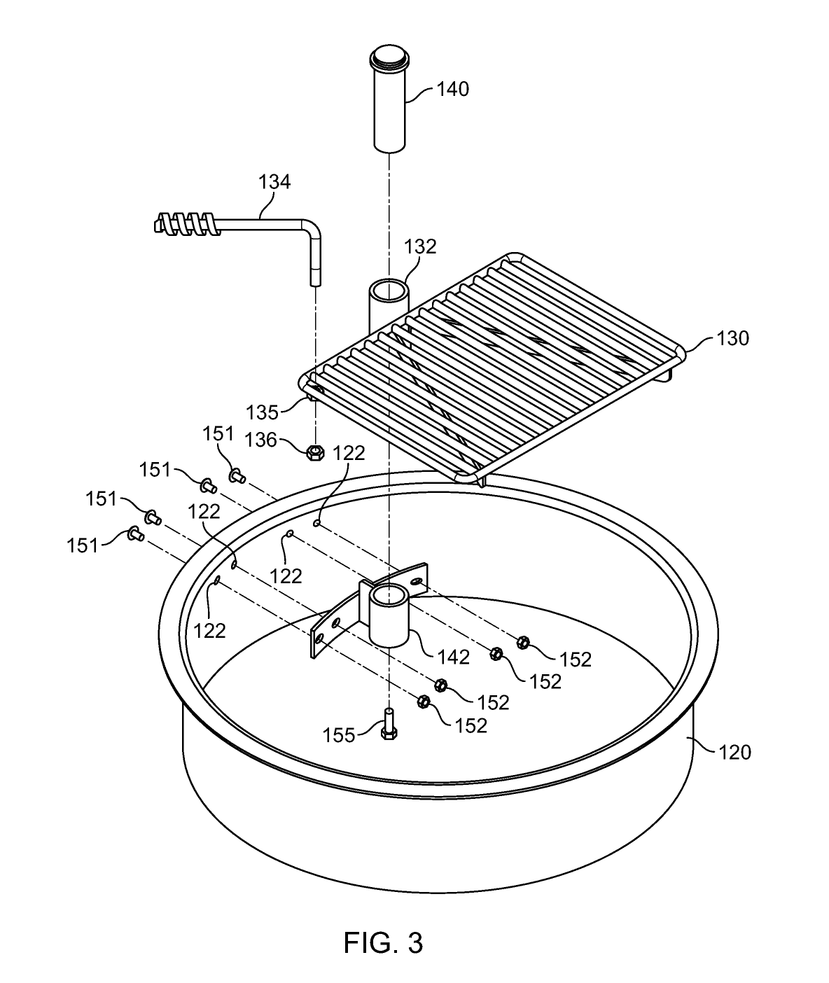

FIG. 3 shows an expanded view of how a fire-pit insert 120 can be attached to a swiveling grate 130. The grate 130 includes barrel 132 adapted to receive a swivel grate post 140. The swivel grate post 140 also passes through a second barrel of a mounting bracket 142. The swivel grate post 140 is pivotally secured to the grate 130 and the mounting bracket 142 so that the mounting bracket and the grate 130 can swivel with respect to each other. A cap screw 155 can be used to pivotally secure the grate 130, the mounting bracket 142 and the swivel grate post 140. The grate 130, swivel grate post 140, mounting bracket 142, and the associated screws, nuts, and bolts can be placed within the fire-pit insert 120 in the fire pit assembly kit 200.

As shown, a mounting bracket 142 can be attached to an inside surface of the fire-pit insert 120. As shown, the mounting bracket 142 can be attached by carriage bolts 151 and hex nuts 152. The carriage bolts 151 can pass through apertures 122 in the fire-pit insert 120. In other embodiments, the mounting bracket 142 can be welded to the inside wall of the fire-pit insert 120. In some embodiments, the fire-pit assembly kit can come with the mounting bracket 142 attached to the fire-pit insert. In other embodiments, the fire-pit assembly kit can come with the mounting bracket 142 and the associated bolts and nuts disassembled.

A handle 134 can be secured to the grate 130. As shown in FIG. 3, the handle is secured to the grate at a corner 135 of the grate 130 by a nut 136. The handle 134 can also be placed within the fire-pit insert 120 in the fire pit assembly kit 200.

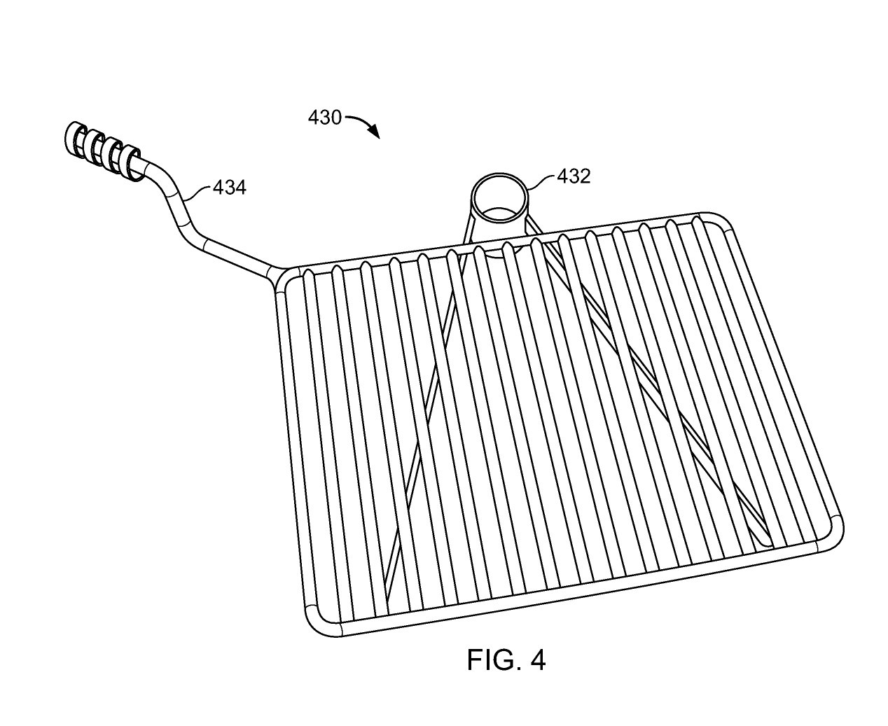

As shown in FIG. 4, a grate can also include different arrangements. Grate 430 includes a handle 434 that is welded onto a corner of the grate 430. Grate 430 also includes a barrel 434 to allow for a pivotal attachment to a fire-pit insert. Grate 434 can also be placed within the fire-pit insert 120 in the fire-pit assembly kit 200.

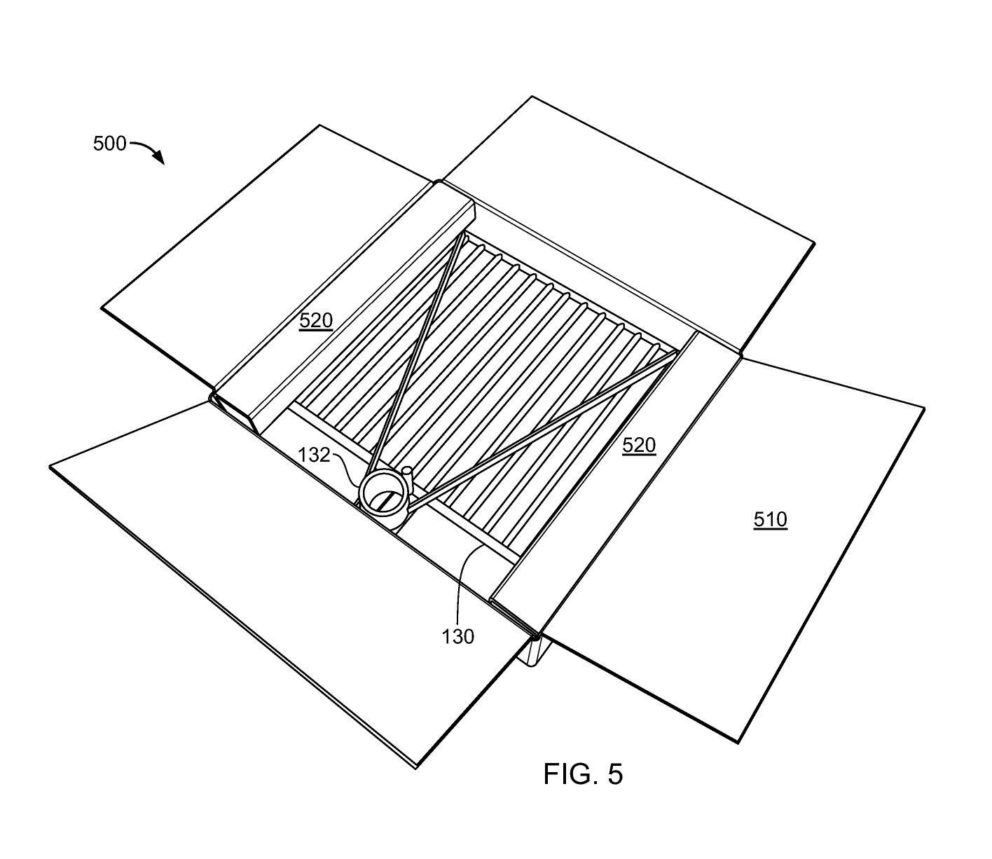

FIG. 5 is a perspective view of a packaged grate. The packaged grate 130 can also include the other parts shown in FIG. 3 in the box 510. For example, screws, bolts, and nuts can be included in cardboard roles 520. In other embodiments, the grate 130 can be packaged alone. The packaged grate 500 can be placed inside the fire-pit insert 120 in the fire pit assembly kit 200.

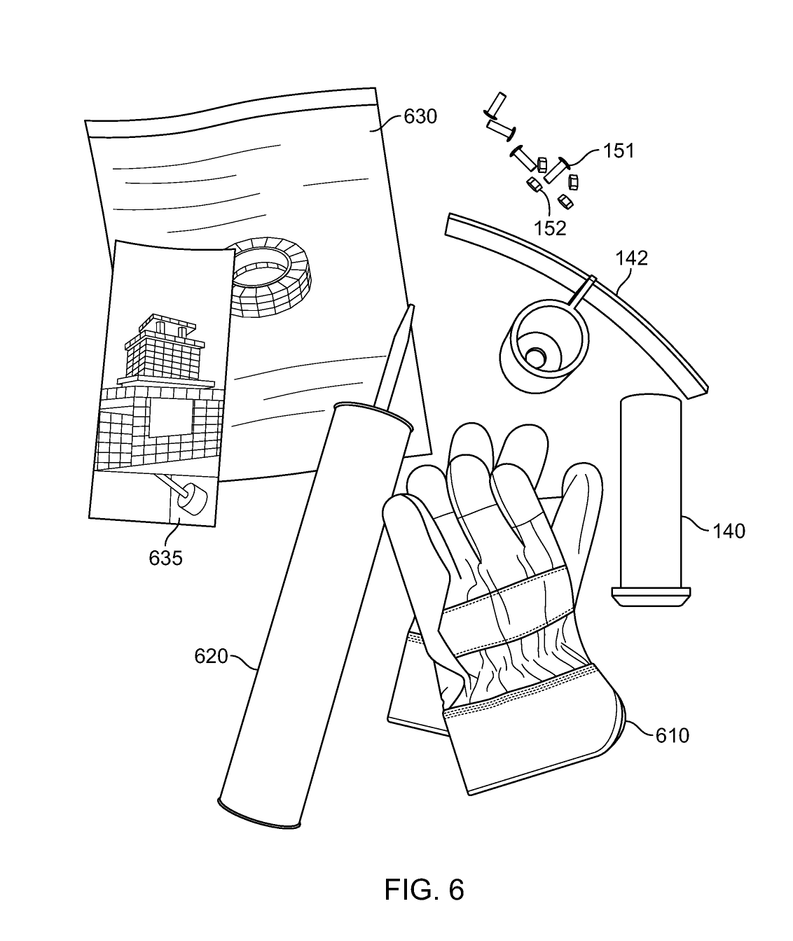

FIG. 6 shows possible accessories that may be included with the fire-pit assembly kit 200. As shown, gloves 610 can be included to help a workman carry and arrange the blocks 110. An adhesive 620 can be included in the kit 200 to allow the workman to secure the blocks 110 together in the desired locations. As noted above, the blocks 110 can be mortarless in that they can be assembled without the use of adhesive or mortar and still withstand normal environmental exposure. An adhesive, however, can optionally be used to further resist environmental forces. In other embodiments, mortar can be included in the kit 200 addition to or in place of adhesive. Instructions 630 for assembling the fire pit and/or marketing materials 635 can also be placed in the kit 200. FIG. 6 also depicts a mounting bracket 142 and associated bolts 151 and nuts 152 and a swivel grate post 140, which can also be included in the kit 200. Additional items optionally included in the fire-pit assembly kit 200 include shovels, grilling utensils, and/or fire manipulation tools.

FIG. 7 shows an example of how fire pit assembly kits may be arranged for shipping. As shown, the fire pit assembly kits can be placed on pallets 720 and stacked. As discussed above, the pallets 720 can facilitate shipment to an access point where workmen can disassemble the kit 200 and move the individual elements of the kit to an assembly point. The pallets 720 can be picked up using forklifts or similar equipment. Accordingly, the kits 200 can be assembled and placed on pallets 720 at a manufacturing facility, moved to a shipping container, moved from a shipping container to a store shelf or warehouse by a forklift, and then moved from the store or warehouse to a vehicle for delivery to the access point. The manufacturing facility, the store and/or warehouse, and the final access point can be more than 1 mile apart, more than 10 miles apart, or more than 100 miles apart. Kits 200, each having a pallet underneath, can be stacked on top of each other within the shipping container, on a warehouse shelf, on a store shelf, or even at an access point. In some cases, two, three, four, five, or more pallets each containing an at least partially assembled fire pit arrangement (e.g., a fire pit assembly shown in FIG. 1) can be stacked on top of each other.

Although certain embodiments are described in detail, other embodiments are within the scope of the claims below.

What is claimed is:

1. Afire-pit assembly kit, comprising a fire-pit insert packaged with a plurality of blocks arranged around the fire-pit insert.

2. The fire-pit assembly kit of claim 1, further comprising a material wrapped around the fire-pit insert and the plurality of blocks to hold the kit together.

3. The fire-pit assembly kit of claim 1, further comprising a pallet, the fire-pit insert and the plurality of blocks being stacked on the pallet.

4. The fire-pit assembly kit of claim 1, wherein the fire-pit insert comprises metal.

5. The fire-pit assembly kit of claim 1, wherein the fire-pit insert comprises stainless steel.

6. The fire-pit assembly kit of claim 1, wherein the fire-pit insert is circular.

7. The fire-pit assembly kit of claim 1, wherein the plurality of blocks comprise trapezoidal-shaped blocks.

8. The fire-pit assembly kit of claim 1, further comprising a grate.

9. The fire-pit assembly kit of claim 1, wherein the grate is within the fire-pit insert.

10. The fire-pit assembly kit of claim 9, further comprising a pivot post, wherein the pivot post is adapted for attachment to the grate to permit the grate to pivot with respect to the fire-pit insert.

11. The fire-pit assembly kit of claim 9, further comprising a mounting bracket, wherein the mounting bracket is adapted to be secured to the fire-pit insert by bolts, screws, nuts, or a combination thereof or is welded onto the fire-pit insert.

12. The fire-pit assembly kit of claim 9, further comprising a handle adapted to be attached to the grate.

13. The fire-pit assembly kit of claim 1, wherein multiple layers of rings of the blocks are stacked around the fire-pit insert.

14. The fire-pit assembly kit of claim 1, wherein the plurality of blocks are arranged such that a height of the blocks is greater than the height of the fire-pit insert.

15. The fire-pit assembly kit of claim 1, wherein the plurality of blocks are not adhered together in the kit.

16. A method of shipping a fire-pit assembly system comprising a plurality of blocks and a fire-pit insert, wherein said method comprising:
arranging, on a pallet, the plurality of blocks to form a ring around the fire-pit insert thereby forming an at least partially assembled arrangement; and
moving said pallet from a first location to a second location.

17. The method of claim 16, wherein said arrangement is wrapped in a packing material to hold the plurality of blocks in said arrangement during the moving of said pallet from the first location to the second location.

18. The method of claim 16, wherein a plurality of said arrangements present of separate pallets are stacked on top of each other during said moving step.

19. The method of claim 16, wherein the first location is at least 10 miles from the second location.

20. A method of preparing multiple fire-pit assembly systems for delivery to a customer, wherein said method comprises:
(a) arranging, on a first pallet, a plurality of blocks around a fire-pit insert to form an at least partially assembled arrangement on said first pallet;
(b) arranging, on a second pallet, a plurality of blocks around a second fire-pit insert to form an at least partially assembled arrangement on said second pallet; and
(c) stacking said first pallet on top of said second pallet.
